(19) United States
(12) Patent Application Publication
(10) Pub. No.: US 2011/0006973 A1
(43) Pub. Date: Jan. 13, 2011

(54) LED DISPLAY DEVICE

(75) Inventor: Hui-Chung Lin, Shenzhen City (CN)

Correspondence Address: KIRTON AND MCCONKIE, 60 EAST SOUTH TEMPLE,, SUITE 1800, SALT LAKE CITY, UT, 84111, US

(73) Assignee: SHENZHEN DISPLEDTECH. CO., LTD, Shenzhen City (CN)

(21) Appl. No.: 12/920,438

(22) PCT Filed: Aug. 27, 2009
(86) PCT No.: PCT/CN2009/073556

§ 371 Date: Aug. 31, 2010

(30) Foreign Application Priority Data
Aug. 29, 2008 (CN) 200820147025.4

(51) Int. Cl. G09G 3/32

(52) U.S. Cl. 345/83

(57) ABSTRACT

The present invention relates to the display field, and provides a LED display device. The LED display device comprises a data acquisition unit configured for acquiring image data; a data conversion unit configured for performing a data-conversion operation for the image data; and a LED display unit configured for displaying data converted by the data conversion unit. The LED display unit comprises a plurality of LED groups consisted of red LEDs, green LEDs, blue LEDs and white LEDs. The LED display device of the present invention employs the LEDs with four colors to compose a pixel, and employs the white LED to emit white light configured for replacing the white light formed by blending RGB light. Thus the LED display device reduces the power consumption and saves the energy.

### BACKGROUND

1. Field of the Invention

The present invention relates to the display field, and more particularly to a LED display device.

2. Description of the Related Art

The conventional LED (light-emitting diode) display technology generally employs a scheme of red (R), green (G) and blue (B) three primary colors. As shown in FIG. 1, each pixel 10 is consisted of a red LED, a green LED and a blue LED. When wanting to display a white color, the RGB three primary colors are blended to form the white color according to the three primary colors blending theory.

However, the power consumption of the LED display screen is very high. For example, for a display screen with P10 and 78.6 m², the power consumption thereof is about 59KW. That is, the power consumption of the LED display screen in a day equals to the power consumption of an ordinary family in 7-9 months. Such high power consumption thereof greatly wastes the energy.

### BRIEF SUMMARY

The present invention relates to a LED display device which can solve the problem of the conventional LED display device consuming the more power consumption and wasting the energy since the conventional LED display device blends the RGB light to form the white light.

A LED display device in accordance with an exemplary embodiment of the present invention comprises: a data acquisition unit configured for acquiring image data; a data conversion unit configured for performing a data-conversion operation for the image data acquired by the data acquisition unit; and a LED display unit configured for displaying data converted by the data conversion unit. The LED display unit comprises a plurality of LED groups consisted of red LEDs, green LEDs, blue LEDs and white LEDs.

The LED display device of the present invention employs the LEDs with four colors to compose a pixel, and employs the white light emitted from the white LEDs to replace the white light formed by blending RGB light. Thus the LED display device of the present invention can reduce the power consumption and save the energy.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an arraying schematic view of a single pixel consisted of RGB LEDs of the conventional technology.

FIG. 2 is a block schematic view of a LED display device in accordance with an exemplary embodiment of the present invention.

FIG. 3 is an arraying schematic view of a single pixel consisted of RGBW LEDs in accordance with an exemplary embodiment of the present invention.

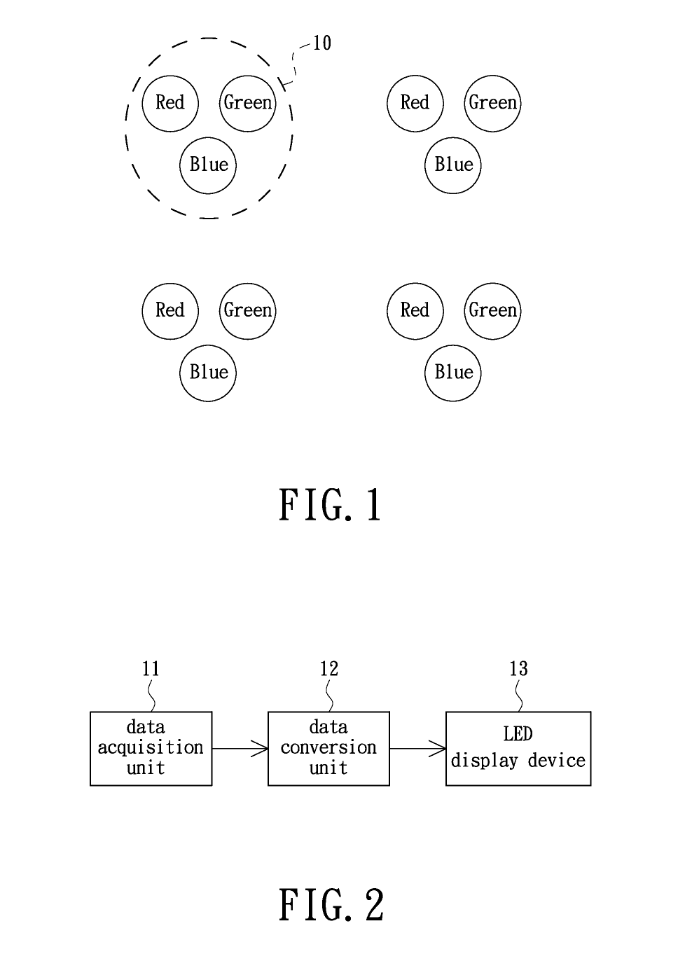

### DETAILED DESCRIPTION

Reference will now be made to the drawings to describe exemplary embodiments of the present LED display device, in detail. The following description is given by way of example, and not limitation.

An LED display device in accordance with an exemplary embodiment of the present invention employs LEDs with four colors to compose a pixel, and employs a white LED to emit white light for replacing the white light formed by blending RGB light. Thus the LED display device can reduce the power consumption and save the energy.

The LED display device in accordance with the exemplary embodiment of the present invention may be a LED display screen, or a LED display tube, or other LED video or image display equipment. FIG. 2 is a block schematic view of the LED display device. For ease of presentation, FIG. 2 only shows those related to the present invention, which will be described in following.

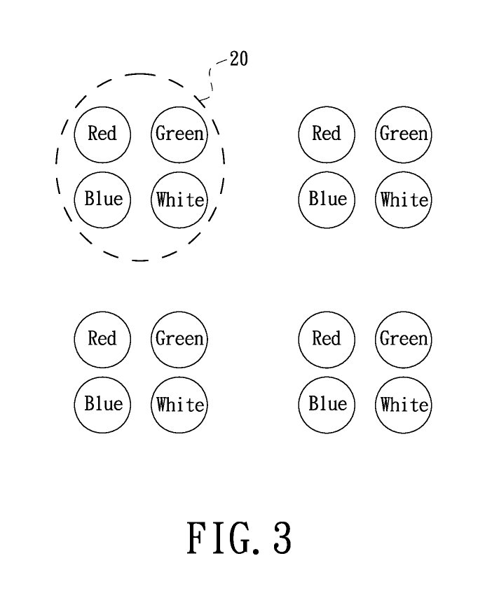

The LED display device comprises a data acquisition unit 11 configured for acquiring image data, a data conversion unit 12 configured for performing a data-conversion operation for the image data acquired by the data acquisition unit 11, a LED display device 13 configured for displaying data converted by the data conversion unit 12. The LED display unit 13 comprises a plurality of LED groups consisted of red LEDs, green LEDs, blue LEDs and white LEDs. As an exemplary embodiment of the present invention, each of the LED groups is used as a pixel. As shown in FIG. 3, each pixel is consisted of a red LED, a green LED, a blue LED and a white LED. The LEDs as shown in FIG. 3 do not represent the amount of the actual LEDs, and they are only used to describe the colors of a single pixel. The amount of the LEDs may be determined by the actual need.

As an exemplary embodiment of the present invention, the LED display unit further comprises a driving module configured for driving the red LEDs, the green LEDs, the blue LEDs and the white LEDs. The driving module may be a constant-current shift register.

In this exemplary embodiment of the present invention, the data conversion unit 12 performs the data-conversion operation for the image data acquired by the data acquisition unit 11. The detailed data-conversion operation comprises: firstly calculating a minimum value of a first red gray value R0, a first green gray value G0, a first blue gray value B0; then enduing a white gray value W1 with the calculated minimum value, that is, W1=min (R0, G0, B0); finally calculating a second red gray value R1, a second green gray value G1 and a second blue gray value B1 according to the white gray value W1, the first red gray value R0, the first green gray value G0, and the first blue gray value B0, that is, R1=R0−W1, G1=G0−W1, B1=B0−W1.

For a same electrical power, the light-emitting efficiency of the white LED is greatly larger than those of the red, green, blue LEDs respectively. For example, when the current is 20 mA and the light-emitting angles thereof are same, the luminance of the red LED is 300 mcd, the luminance of the green LED is 400 mcd, the luminance of the blue LED is 150 mcd, and the luminance of the white LED is 1700 mcd.

The LED display device of the exemplary embodiment of the present invention employs the R, G, B, W LEDs to compose a whole display pixel, and employs the W LED to emit the white light configured for replacing the white light formed by blending the R, G, B light. If using the current with 20 mA to drive, the red LED is 255 level luminance and the physical luminance thereof is 200 mcd; the green LED is 255 level luminance and the physical luminance thereof 400 mcd; the blue LED is 255 level luminance and the physical luminance thereof 70 mcd, thus the white light formed by blending the RGB light is 255 level luminance and the physical luminance thereof 670 mcd. However, the exemplary embodiment of the present invention can employ only a white LED to replace the three LEDs (R, G, B), and the current thereof may be lower than 20 mA. Furthermore, the exemplary embodiment of the present invention can save about 60% power consumption.

When displaying a single-color image, the white LED does not work and the scheme at this moment is same to the conventional scheme of the three primary colors. When the displayed image data comprises the red, green, blue components, the white LED works to replace the white light formed by blending the RGB light emitted from the R, G, B LEDs. For example, if the red gray value is 128, the green gray value is 64 and the blue gray value 32, after the image data is converted by the data conversion unit, the values thereof change to be: the red gray value is 96, the green gray value is 32, the blue gray value is 0, and the white gray value is 32. At this moment, the total current of the LEDs with the four colors is 11 mA less than the total current of the LEDs with the three colors. Thus the present invention can reduce the power consumption, and save the energy.

The LED display device of the exemplary embodiment of the present invention employs the LEDs with the four different colors to compose the pixel, and employs the white light emitted from the white LED to replace the white light formed by blending the RGB light. Thus the LED display device of the exemplary embodiment can reduce the power consumption and save the energy.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A LED display device, comprising:
a data acquisition unit configured for acquiring image data;
a data conversion unit configured for performing a data-conversion operation for the image data acquired by the data acquisition unit; and
a LED display unit configured for displaying data converted by the data conversion unit;
wherein the LED display unit comprises a plurality of LED groups consisted of red LEDs, green LEDs, blue LEDs and white LEDs.

2. The LED display device as claimed in claim 1, wherein the LED display unit further comprises a driving module configured for driving the red LEDs, the green LEDs, the blue LEDs and the white LEDs.

3. The LED display device as claimed in claim 1, wherein each of the LED groups is used as a pixel.
